(19) United States
(12) Patent Application Publication
(10) Pub. No.: US 2020/0211140 A1
(43) Pub. Date: Jul. 2, 2020

(54) DYNAMIC BUS ROUTING

(71) Applicant: Proterra Inc., Burlingame, CA (US)

(72) Inventor: Matthew HORTON, Menlo Park, CA (US)

(73) Assignee: Proterra Inc., Burlingame, CA (US)

(21) Appl. No.: 16/723,130

(22) Filed: Dec. 20, 2019

Related U.S. Application Data
(60) Provisional application No. 62/786,072, filed on Dec. 28, 2018.

(51) Int. Cl. G06Q 50/26; G06Q 10/06; G01C 21/34; G06Q 10/04

(52) U.S. Cl. CPC G06Q 50/26; G06Q 10/06311; G08G 1/123; G06Q 10/06312; G06Q 10/047; G01C 21/3415

(57) ABSTRACT

A computer-implemented method for dynamic bus routing includes receiving a request from a commuter for transportation from an origin to a destination, determining a commuter bus route to service the commuter request, determining a transportation network company (TNC) schedule from the origin to a commuter bus pick-up point for the commuter, scheduling a commuter bus trip from the commuter bus pick-up point to a commuter bus drop-off point for the commuter, determining a TNC schedule from the commuter bus drop-off point to the destination for the commuter, dispatching a first TNC driver to the origin for the commuter and scheduling a dispatch of a second TNC driver to the commuter bus drop-off point for the commuter.

### CROSS-REFERENCE TO RELATED APPLICATIONS

This application claims the benefit of U.S. Provisional Application No. 62/786,072, filed Dec. 28, 2018, the disclosure of which is incorporated herein by reference in its entirety.

### TECHNICAL FIELD

Various embodiments of the present disclosure relate generally to routing and scheduling for public transportation systems and, more particularly, to dynamic routing and coordination of transportation provided by transportation network companies (TNCs) and commuter buses.

### BACKGROUND

In many urban and suburban commuting environments, commuters may travel from a dense residential neighborhood to a distant dense business district. For reasons of convenience, commuters commonly rely on personal automobiles for such a commute even though alternatives, such as transportation network companies (TNCs) and commuter buses are available. This reliance on personal automobiles—often with a single occupant—may result in increased road congestion, air pollution, resource consumption, and wear on transportation infrastructure. In addition, commuters on long trips between home and work suffer from lost productivity while commuting. Public transit is cost-effective, but inconvenient, while TNCs may be convenient but not cost-effective. Neither solution maximizes commuter productivity

At the same time, TNC operators seeking to expand their service offerings may provide a shared commute service, but the high cost of a human driver makes the service too expensive for all but the shortest commutes, even for rides shared by multiple commuters. Public transit, such as by commuter bus, provides a low cost per passenger mile, but rigid schedules and a limited number of access points makes such a service inconvenient for a majority of commuters. For this reason, most commuters do not consider public transit as a viable solution to their commutes. Furthermore, an individual commuter lacks the ability to coordinate TNC services and commuter bus schedules to achieve a seamless and convenient combined commuting solution.

The present disclosure is directed to overcoming one or more of these above-referenced challenges.

### SUMMARY OF THE DISCLOSURE

According to certain aspects of the present disclosure, systems and methods are disclosed for dynamic bus routing.

In one embodiment, a computer-implemented method is disclosed for dynamic bus routing, the method comprising: receiving a request from a commuter for transportation from an origin to a destination, determining a commuter bus route to service the commuter request, determining a transportation network company (TNC) schedule from the origin to a commuter bus pick-up point for the commuter, scheduling a commuter bus trip from the commuter bus pick-up point to a commuter bus drop-off point for the commuter, determining a TNC schedule from the commuter bus drop-off point to the destination for the commuter, dispatching a first TNC driver to the origin for the commuter and scheduling a dispatch of a second TNC driver to the commuter bus drop-off point for the commuter.

In accordance with another embodiment, a system is disclosed for dynamic bus routing, the system comprising: a data storage device storing instructions for dynamic bus routing in an electronic storage medium; and a processor configured to execute the instructions to perform a method including: receiving a request from a commuter for transportation from an origin to a destination, determining a commuter bus route to service the commuter request, determining a transportation network company (TNC) schedule from the origin to a commuter bus pick-up point for the commuter, scheduling a commuter bus trip from the commuter bus pick-up point to a commuter bus drop-off point for the commuter, determining a TNC schedule from the commuter bus drop-off point to the destination for the commuter, dispatching a first TNC driver to the origin for the commuter and scheduling a dispatch of a second TNC driver to the commuter bus drop-off point for the commuter.

In accordance with another embodiment, a non-transitory machine-readable medium storing instructions that, when executed by the a computing system, causes the computing system to perform a method for dynamic bus routing, the method including: receiving a request from a commuter for transportation from an origin to a destination, determining a commuter bus route to service the commuter request, determining a transportation network company (TNC) schedule from the origin to a commuter bus pick-up point for the commuter, scheduling a commuter bus trip from the commuter bus pick-up point to a commuter bus drop-off point for the commuter, determining a TNC schedule from the commuter bus drop-off point to the destination for the commuter, dispatching a first TNC driver to the origin for the commuter and scheduling a dispatch of a second TNC driver to the commuter bus drop-off point for the commuter.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that TNC services and commuter bus schedules may be coordinated with dynamic route and schedule adjustments. The disclosed systems and methods discussed below may allow improved commuting solutions.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts a typical system infrastructure for commuting between home and a business.

FIG. 1B depicts an exemplary system infrastructure for commuting between home and a business, according to one or more embodiments.

FIG. 2 depicts an exemplary system and infrastructure for dynamic bus routing for commuting between home and a business, according to one or more embodiments.

FIG. 3 depicts a detailed configuration of a transportation management engine for dynamic bus routing, according to one or more embodiments.

FIG. 4 depicts a flowchart of a method of dynamic bus routing, according to one or more embodiments.

FIGS. 5A-5B depict a message flow in an example process for dynamic bus routing, according to one or more embodiments.

FIG. 6 depicts a computing device for dynamic bus routing, according to one or more embodiments.

### DETAILED DESCRIPTION OF EMBODIMENTS

Various embodiments of the present disclosure relate generally to providing dynamic routing of commuter buses and other means of transportation.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

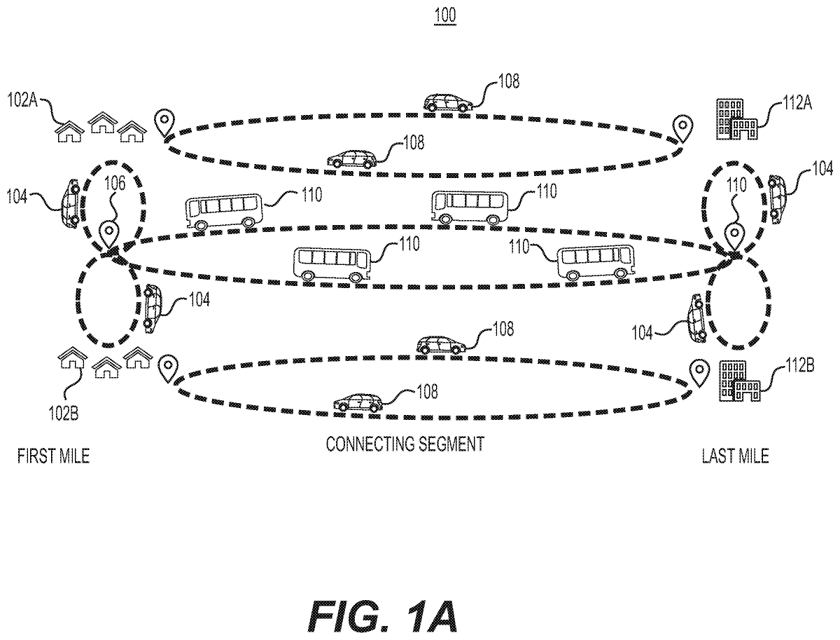

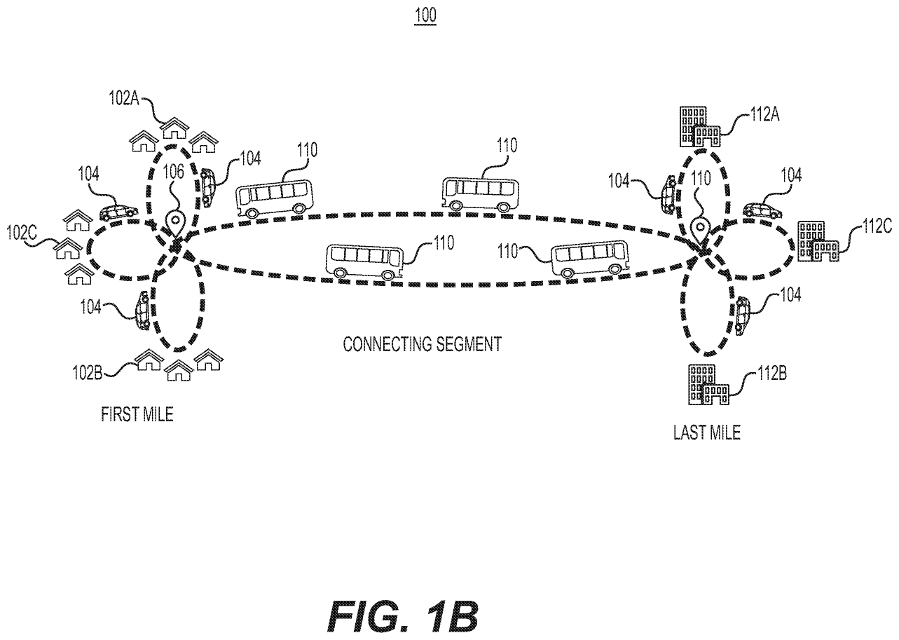

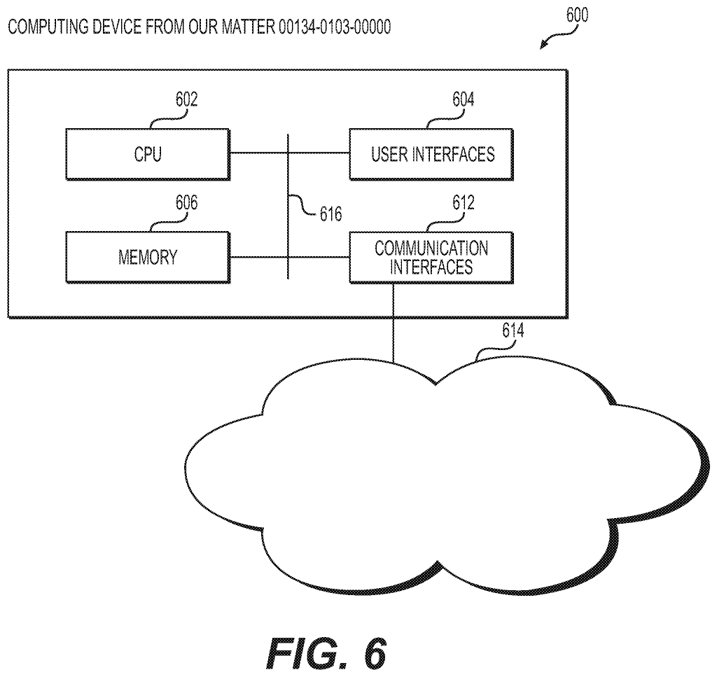

Any suitable system infrastructure may be put into place to allow dynamic bus routing. FIGS. 1-3 and 6 and the following discussion provide a brief, general description of a suitable environment in which the present disclosure may be implemented. In one embodiment, any of the disclosed systems, methods, and/or graphical user interfaces may be executed by or implemented by a computing system consistent with or similar to that depicted in FIG. 6. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

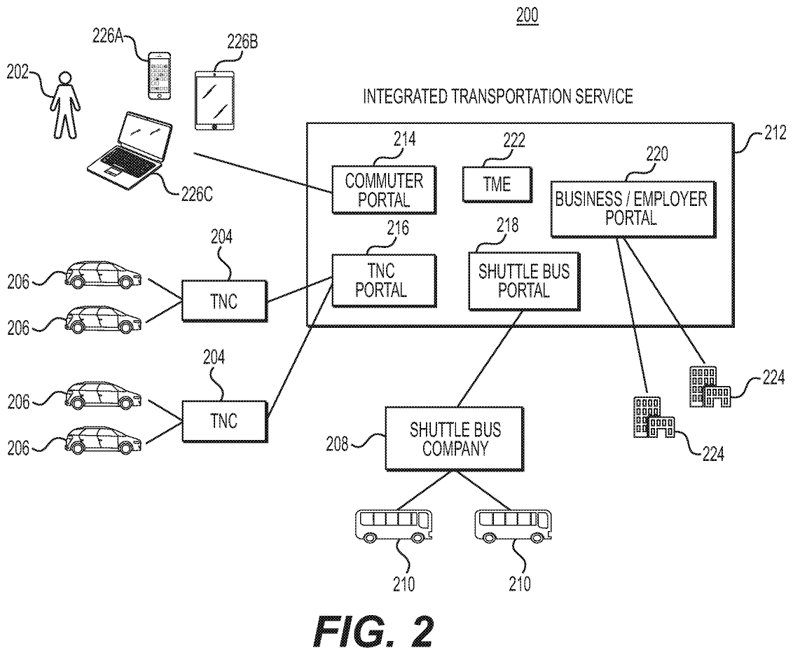

As shown in FIG. 1A, a commuter, such as commuter 202 depicted in FIG. 2, may travel from an origin, such as a dense residential neighborhood (102A, 102B), to a destination, such as a dense business district (112A, 112B). The commuter may initially travel over surface streets within a residential neighborhood, such as neighborhood 102A. This portion of the commute may be referred to as the “first mile” of the trip. The commute may then continue over longer distances, such over a highway, turnpike, toll road, or other high speed route. This portion of the commute may be referred to as a “connecting segment.” Finally, the commuter may travel over surface streets within a business district, such as business district 112A. This portion of the commute may be referred to as the “last mile” of the trip. In a typical scenario, the commuter may undertake each portion of the commute in a personal automobile 108, often without any other passengers. As discussed above, such a commute may result in increased road congestion, air pollution, resource consumption, and wear on transportation infrastructure. In addition, the commuter may incur expenses for fuel as well as maintenance and wear and tear on personal automobile 108.

Alternative transportation may be available to the commuter. For example, one or more transportation network companies (TNCs) 104 may operate within the “first mile” of the residential neighborhoods 102 and the “last mile” of the business districts 112. However, TNCs may not efficiently provide service along the “connecting segment” of a commute. Commuter buses 110 may be available along the “connecting segment,” such as between a terminal 106 near residential neighborhoods 102 and a terminal 114 near business districts 112. Use of these modes of transportation may reduce some of the costs associated with the personal automobile. However, coordinating these services over the “first mile,” “connecting segment,” and “last mile” into a time- and cost-efficient commute may be difficult for an individual commuter.

FIG. 1B depicts an exemplary system infrastructure for commuting between home and a business, according to one or more embodiments. As shown in FIG. 1B, the commuter may travel the “first mile” between a residential neighborhood 102 and a commuter bus terminal 106 using TNC 104 instead of personal automobile 108. From terminal 106, the commuter may use commuter bus 110 to travel over the “connecting segment” to terminal 114. From terminal 114, the commuter may travel the “last mile” to a business district 112 using a TNC 104. If multiple commuters are traveling from terminal 114 to the same business district, TNC 104 may offer a shared ride to the commuters. Terminals 106 and 114 may be existing public bus terminals or stops or may be non-traditional stops, such as parking lots or other open spaces. The ability to flexibly determine pick-up and drop-off points may further facilitate dynamic scheduling and routing, as discussed in more detail below. For example, a location of terminals 106 and 114 may be determined based on proximity to the start and end points of the commutes for each of the commuters riding on a single bus. Such a commute may be more efficient in the use of resources and may reduce other costs, such as environmental damage and wear and tear on infrastructure. However, coordinating the resources required for such a commute, including TNCs 104 and commuter buses 110, may require a centralized service, such as the integrated transportation service 212 depicted in FIG. 2. Although FIG. 1B, and the exemplary embodiments discussed below, describe a commute as beginning at a commuter's home and ending at a place of employment, the exemplary embodiments should be understood to equally apply to a commute between a place of employment and a home, or to travel between any other two points of interest to a traveler.

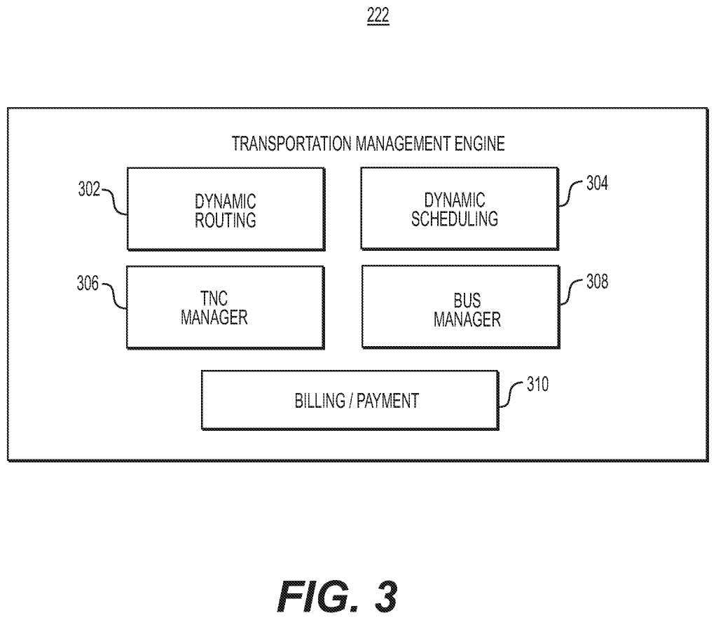

As shown in FIG. 2, an integrated transportation service 212 may include a commuter portal 214, a TNC portal 216, a shuttle bus portal 218, a business/employer portal 220, and a transportation management engine (TME) 222. TME 222 will be discussed in greater detail below with respect to FIG. 3. Each of the commuter 202, TNC 204, bus company 208, and business/employer 224 may interface with the integrated transportation service by way of dedicates portals, such as the commuter portal 214, TNC portal 216, bus portal 218, and business/employer portal 220, respectively. Each portal may be, for example, a web-accessible page providing specific functionality for each type of user, an application programming interface (API) providing functionality for remote applications, an application running on a mobile or desktop device belonging to a user, etc. For example, commuter 202 may access commuter portal 214 by way of an application running on laptop 226C, an app running on tablet 226B or mobile phone 226A, or a web page accessible from any of these devices.

By way of commuter portal 214, commuter 202 may perform tasks related to a one-time or regularly scheduled commute such as, for example, scheduling a one-time trip, scheduling a recurring trip including frequency (daily, weekly, specific days of the week, etc.), establishing payment method(s), reviewing and paying bills, setting other preferences (preferred TNCs or drivers for each TNC, type of TNC vehicle, etc.), receiving alerts and notifications relating to a current or future scheduled trip, such as schedule or routing changes, etc. A scheduled trip may be round-trip or one-way and may include user-selected origin and destination, desired pick-up time and/or arrival time at destination, intermediate stops within the “first mile” or “last mile,” or other instructions for the commute, such as avoiding certain routes or type of streets (e.g., avoiding highways). A scheduling or routing change may include, for example, an earlier or later pickup or drop-off time, a changes in pickup or drop-off location, a change in intermediate transfer location, a change in TNC or TNC driver, or cancellation of a trip, etc.

By way of TNC portal 216, TNC 204 may perform tasks related to providing transportation within the “first mile” and “last mile” of a trip, including receiving a request for a trip including origin and destination, desired pick-up time and/or arrival time at destination, intermediate stops, etc., receiving notification of schedule and/or routing changes, submitting invoices and receiving payments. A request for a trip may also include specified commuter preferences, such as particular drivers or vehicle types. TNC 204 may store commuter identities and preferences for later use and may collect and store other commuter-related information. TNC 204 may use the received trip request to schedule and dispatch TNC driver and vehicle 206. Notification of the particular vehicle and driver dispatched for a commuter may be made by way of commuter portal 214 or a portal or web application provided by TNC 204.

By way of bus portal 218, bus company 208 may perform tasks related to providing transportation within the “connecting segment” of a trip, including receiving request for a trip including pick-up point and drop-off point, desired pick-up time and/or arrival time at destination, intermediate stops, etc., receiving notification of schedule and/or routing changes, submitting invoices and receiving payments. A request for a trip may also include specified commuter preferences, such as desired amenities (food, beverages, wireless network availability, etc.) provided during the trip. Bus company 208 may use the received trip request to schedule and dispatch bus 210. Bus company 208 may store commuter identities and preferences for later use and may collect and store other commuter-related information.

By way of business/employer portal 220, business/employer 224 may perform tasks related to supporting business transportation needs, such as, for example, providing commuting subsidies for employees, scheduling trips for individual employees or groups of employees, scheduling trips for business visitors or other outside groups or individuals, establishing payment method(s), reviewing and paying bills, receiving notification of commuting benefits provided to employees, setting other preferences, etc.

A transportation management engine, such as TME 222 depicted in FIG. 2, may include a dynamic routing module 302, a dynamic scheduling module 304, a TNC manager 306, a bus manager 308, and a billing/payment module 310. Dynamic routing module 302 may automatically adjust a route traveled by a TNC driver or a commuter bus in response to current or expected conditions, including, for example, weather, traffic, road closures, or other conditions. Route adjustments may include changes to pick-up or drop-off points for a TNC driver or a commuter bus. Dynamic scheduling module 304 may automatically adjust the scheduling of a TNC driver or a commuter bus in response to factors including, for example, a delay in the commuter being picked up by the TNC driver, a delay in the availability of a commuter bus, a delay of the commuter bus en route to the commuter bus drop-off point, a request by the commuter to expedite an arrival time, delays or other schedule changes resulting from dynamic routing by dynamic routing module 302, etc. TNC manager 306 may interact with a TNC company, such as TNC company 204 depicted in FIG. 3, or a TNC driver, such as TNC driver 206, to complete transactions related to TNC services provided to a commuter such as, for example, requesting dispatch of a TNC driver to a commuter's location, notifying the TNC company or the TNC driver of a change in schedule or route, such as may be determined by dynamic routing module 302 or dynamic scheduling module 304, receiving invoices for services provided by the TNC company, making payments to the TNC company, etc. Bus manager 308 may interact with a bus company, such as bus company 208 depicted in FIG. 3, to complete transactions related to bus services provided to a commuter such as, for example, arranging bus transportation from a bus pick-up point to a bus drop-off point, notifying the bus company of a change in schedule or route, such as may be determined by dynamic routing module 302 or dynamic scheduling module 304, receiving invoices for services provided by the bus company, making payments to the bus company, etc. Billing/payment module 310 may process bills and payments related to a commute such as, for example, receiving invoices from a TNC company or a bus company, receiving employee benefit information from an employer, such as employer 224, sending bills to commuters, receiving payments from commuters, etc. Billing/payment module 310 may further apply dynamic pricing to a commute including, for example, lower prices based on special promotions or surcharges based on high volume, special events, fuel prices, etc. Such dynamic pricing may be determined by the integrated transportation service or by may be in response to dynamic pricing models applied by the TNC company or the bus company.

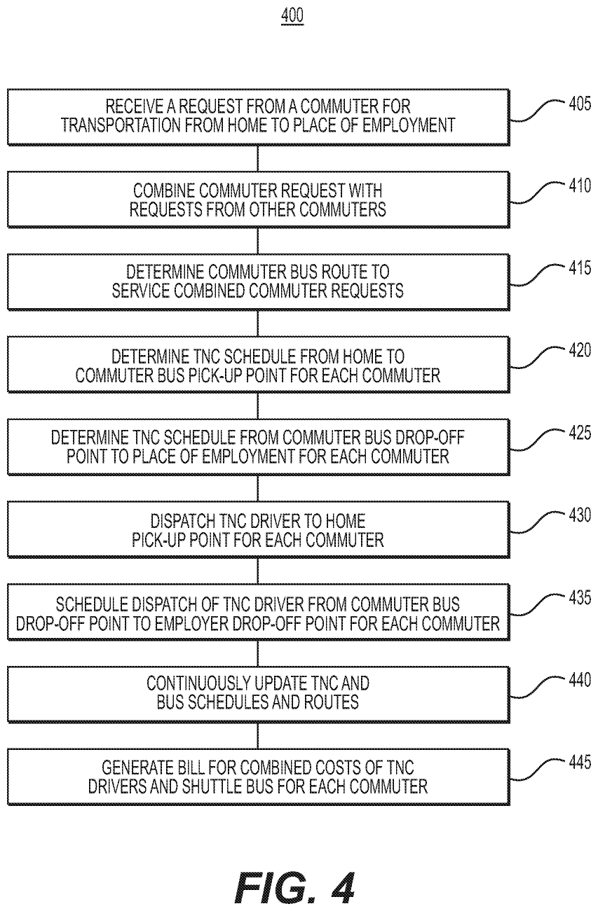

FIG. 4 depicts a flowchart of a method of dynamic bus routing, according to one or more embodiments. As shown in FIG. 4, in operation 405, TME 222 may receive a request from a commuter for transportation from a home to a place of employment. In operation 410, TME 222 may combine the received commuter request with requests from other commuters. In operation 415, TME 222 may determine a commuter bus route to service the combined commuter requests. In operation 420, TME 222 may determine a TNC schedule from the commuter's home to a commuter bus pick-up point for each commuter. In operation 425, TME 222 may determine a TNC schedule from the commuter bus drop-off point to a place of employment for each commuter. In operation 430, TME 222 may dispatch a TNC driver to the home pick-up point for each commuter. In operation 435, TME 222 may schedule a dispatch of a TNC driver from the commuter bus drop-off point to an employer drop-off point for each commuter. In operation 440, TME 222 may continuously update the TNC and bus schedules and routes. In operation 445, TME 222 may generate a bill for the combined costs of the TNC drivers and the shuttle bus for each commuter.

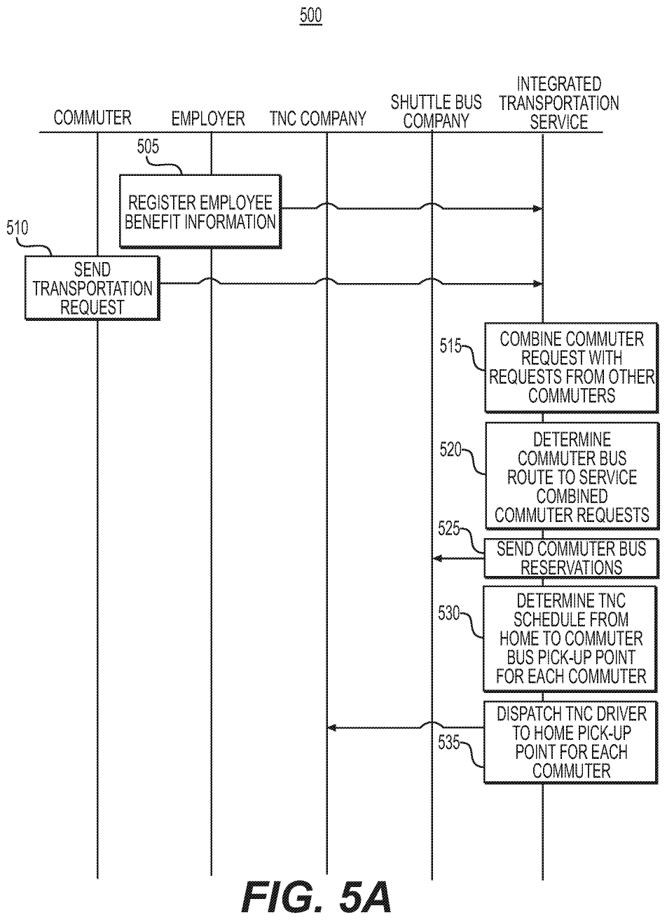

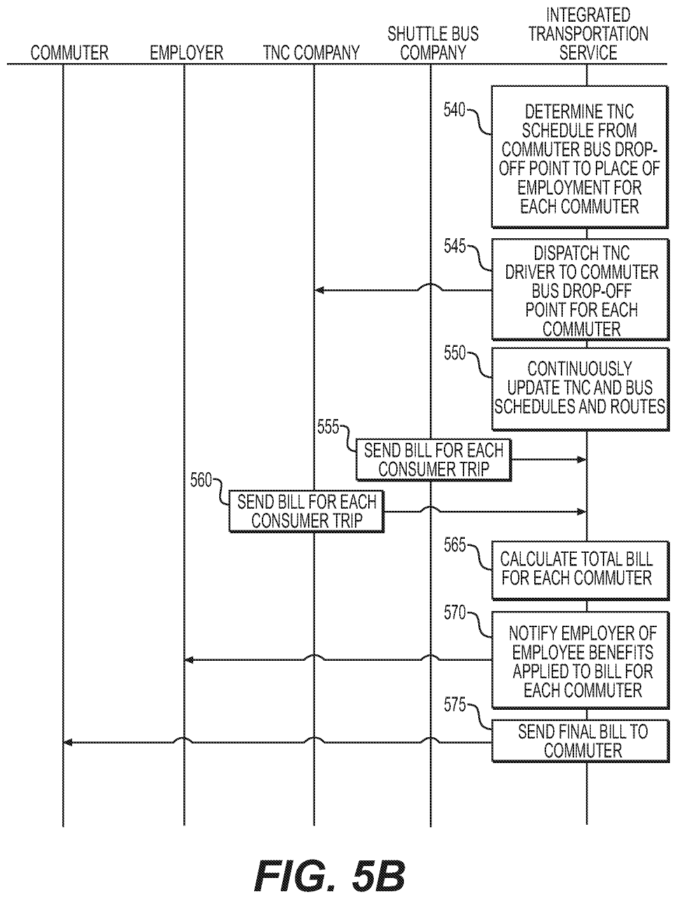

FIG. 5 depicts a message flow in an example process for dynamic bus routing, according to one or more embodiments. In operation 505, employer 224 may register employee benefit information for one or more employees commuting to the employer's place of business. For example, employer 224 may provide commuting subsidies for the commuting employees. In operation 510, commuter 202, who may ben an employee of employer 224, may send a transportation request to the integrated transportation system 212. For example, commuter 202 may schedule a one-time trip or schedule a recurring trip including frequency (daily, weekly, specific days of the week, etc.). A scheduled trip may be round-trip or one-way and may include a user-selected start point and destination, and a desired pick-up time and/or arrival time at destination. In operation 515, integrated transportation service 212 may combine commuter request with requests from other commuters. In operation 520, integrated transportation service 212 may determine a commuter bus route to service the combined commuter requests. In operation 525, integrated transportation service 212 may send bus a commuter reservation request to shuttle bus company 208. In operation 530, integrated transportation service 212 may determine a TNC schedule from each commuter's home to the commuter bus pick-up point for each commuter. In operation 535, integrated transportation service 212 may dispatch a TNC driver to the home pick-up point for each commuter. In operation 540, integrated transportation service 212 may determine a TNC schedule from the commuter bus drop-off point to the place of employment for each commuter. In operation 545, integrated transportation service 212 may dispatch a TNC driver to the commuter bus drop-off point for each commuter. In operation 550, integrated transportation service 212 may continuously update the TNC and commuter bus schedules and routes. In operation 555, commuter bus company 208 may a send bill for each commuter trip to the integrated transportation service 212. In operation 560, TNC 204 may send a bill for each commuter trip to the integrated transportation service 212. In operation 565, integrated transportation service 212 may calculate total bill for each commuter. In operation 570, integrated transportation service 212 may notify employer 224 of employee benefits applied to the bill for each commuter. In operation 575, integrated transportation service 212 may send a final bill to the commuter.

The processes described herein may be performed on or between one or more computing devices that are specially configured to perform the processing described herein. Referring now to FIG. 6, an example computing device 600 is presented. A computing device 600 may be, for example, a server, a computing device that is integrated with other systems or subsystems, a mobile computing device, a cloud-based computing capability, and so forth. The computing device 600 can be any suitable computing device as would be understood in the art, including without limitation, for example, a custom chip, an embedded processing device, a tablet computing device, a POS device 118, a payment processing computing system 124, a payment processing computing system 128, a personal data assistant (PDA), a desktop, a laptop, a microcomputer, a minicomputer, a server, a mainframe, or any other suitable programmable device. According to one or more embodiments, a single component can be replaced by multiple components and multiple components can be replaced by a single component to perform a given function or functions. Except where such substitution would not be operative, such substitution is within the intended scope of the one or more embodiments.

The computing device 600 may include a processor 602 that may be any suitable type of processing unit such as, for example, a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources may further include, for example, distributed computing devices, cloud computing resources, and virtual computing resources in general, etc.

The computing device 600 also may include one or more memories 606 such as, for example, read only memory (ROM), random access memory (RAM), cache memory associated with the processor 602, or other memories such as dynamic RAM (DRAM), static ram (SRAM), programmable ROM (PROM), electrically erasable PROM (EEPROM), flash memory, a removable memory card or disk, a solid state drive, and so forth. The computing device 600 also may include storage media such as, for example, a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor 602, or memories 606 are also contemplated as storage devices. It can be appreciated that such memory can be internal or external with respect to operation of the disclosed embodiments. It can be appreciated that certain portions of the processes described herein may be performed using instructions stored on a non-transitory computer-readable medium or media that direct a computer system to perform the process steps. Non-transitory computer-readable media, as used herein, comprises all computer-readable media except for transitory, propagating signals.

Network and communication interfaces 612 may be configured to transmit to, or receive data from, other computing devices 600 across a network 614. The network and communication interfaces 612 may be, for example, an Ethernet interface, a radio interface, a Universal Serial Bus (USB) interface, or any other suitable communications interface and can include receivers, transmitter, and transceivers. For purposes of clarity, a transceiver may be referred to as a receiver or a transmitter when referring to only the input or only the output functionality of the transceiver. Example communication interfaces 612 may include, for example, wired data transmission links such as Ethernet and TCP/IP. The communication interfaces 612 may include, for example, wireless protocols for interfacing with private or public networks 614. For example, the network and communication interfaces 612 and protocols may include interfaces for communicating with private wireless networks such as, for example, a Wi-Fi network, one of the IEEE 802.11x family of networks, or another suitable wireless network. The network and communication interfaces 612 may include interfaces and protocols for communicating with public wireless networks 612, using, for example, wireless protocols used by cellular network providers, including Code Division Multiple Access (CDMA) and Global System for Mobile Communications (GSM), etc. A computing device 600 may use network and communication interfaces 612 to communicate with hardware modules such as, for example, a database or data store, or one or more servers or other networked computing resources. Data may be encrypted or protected from unauthorized access.

According to one or more embodiments, the computing device 600 may include a system bus 616 for interconnecting the various components of the computing device 600, or the computing device 600 may be integrated into one or more chips such as, for example, a programmable logic device or an application specific integrated circuit (ASIC), etc. The system bus 616 may include, for example, a memory controller, a local bus, or a peripheral bus for supporting input and output devices 604, and communication interfaces 612, etc. Example input and output devices 604 may include keyboards, keypads, gesture or graphical input devices, motion input devices, touchscreen interfaces, one or more displays, audio units, voice recognition units, vibratory devices, computer mice, and any other suitable user interface.

The processor 602 and memory 606 may include nonvolatile memory for storing, for example, computer-readable instructions, data, data structures, program modules, code, microcode, and other software components for storing the computer-readable instructions in non-transitory computer-readable mediums in connection with the other hardware components for carrying out the methodologies described herein. Software components may include, for example, source code, compiled code, interpreted code, executable code, static code, dynamic code, encrypted code, or any other suitable type of code or computer instructions implemented using any suitable methodology including, for example, high-level, low-level, object-oriented, visual, compiled, or interpreted programming language, etc.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for dynamic bus routing, the method comprising:
receiving a request from a commuter for transportation from an origin to a destination;
determining a commuter bus route to service the commuter request;
determining a transportation network company (TNC) schedule from the origin to a commuter bus pick-up point for the commuter;
scheduling a commuter bus trip from the commuter bus pick-up point to a commuter bus drop-off point for the commuter;
determining a TNC schedule from the commuter bus drop-off point to the destination for the commuter;
dispatching a first TNC driver to the origin for the commuter; and
scheduling a dispatch of a second TNC driver to the commuter bus drop-off point for the commuter.

2. The computer-implemented method of claim 1, further comprising:
combining the commuter request with one or more requests from other commuters.

3. The computer-implemented method of claim 2, wherein at least one of the commuter bus pick-up point and the commuter bus drop-off point is based on each origin among the combined requests.

4. The computer-implemented method of claim 2, wherein at least two commuters among the commuter and the other commuters share at least one of the first TNC driver and the second TNC driver.

5. The computer-implemented method of claim 1, further comprising:
dynamically updating the schedule for at least one of the first TNC driver, the commuter bus, and the second TNC driver.

6. The computer-implemented method of claim 1, further comprising:
dynamically updating a route for at least one of the first TNC driver, the commuter bus, and the second TNC driver.

7. The computer-implemented method of claim 1, wherein the commuter travels from the origin to the destination by way of the commuter bus pick-up point and the commuter bus drop-off point using the first TNC driver, the commuter bus, and the second TNC driver.

8. A system for dynamic bus routing, the system comprising:
a data storage device storing instructions for dynamic bus routing in an electronic storage medium; and
a processor configured to execute the instructions to perform a method including:
receiving a request from a commuter for transportation from an origin to a destination;
determining a commuter bus route to service the commuter request;
determining a transportation network company (TNC) schedule from the origin to a commuter bus pick-up point for the commuter;
scheduling a commuter bus trip from the commuter bus pick-up point to a commuter bus drop-off point for the commuter;
determining a TNC schedule from the commuter bus drop-off point to the destination for the commuter;
dispatching a first TNC driver to the origin for the commuter; and
scheduling a dispatch of a second TNC driver to the commuter bus drop-off point for the commuter.

9. The system of claim 8, wherein the system is further configured for:
combining the commuter request with one or more requests from other commuters.

10. The system of claim 9, wherein at least one of the commuter bus pick-up point and the commuter bus drop-off point is based on each origin among the combined requests.

11. The system of claim 9, wherein at least two commuters among the commuter and the other commuters share at least one of the first TNC driver and the second TNC driver.

12. The system of claim 8, wherein the system is further configured for:
dynamically updating the schedule for at least one of the first TNC driver, the commuter bus, and the second TNC driver.

13. The system of claim 8, wherein the system is further configured for:
dynamically updating a route for at least one of the first TNC driver, the commuter bus, and the second TNC driver.

14. The system of claim 8, wherein the commuter travels from the origin to the destination by way of the commuter bus pick-up point and the commuter bus drop-off point using the first TNC driver, the commuter bus, and the second TNC driver.

15. A non-transitory machine-readable medium storing instructions that, when executed by a computing system, causes the computing system to perform a method for dynamic bus routing, the method including:
receiving a request from a commuter for transportation from an origin to a destination;
determining a commuter bus route to service the commuter request;
determining a transportation network company (TNC) schedule from the origin to a commuter bus pick-up point for the commuter;
scheduling a commuter bus trip from the commuter bus pick-up point to a commuter bus drop-off point for the commuter;
determining a TNC schedule from the commuter bus drop-off point to the destination for the commuter;
dispatching a first TNC driver to the origin for the commuter; and
scheduling a dispatch of a second TNC driver to the commuter bus drop-off point for the commuter.

16. The non-transitory machine-readable medium of claim 15, the method further comprising:
combining the commuter request with one or more requests from other commuters.

17. The non-transitory machine-readable medium of claim 16, wherein at least one of the commuter bus pick-up point and the commuter bus drop-off point is based on each origin among the combined requests.

18. The non-transitory machine-readable medium of claim 15, the method further comprising:
dynamically updating the schedule for at least one of the first TNC driver, the commuter bus, and the second TNC driver.

19. The non-transitory machine-readable medium of claim 15, the method further comprising:
dynamically updating a route for at least one of the first TNC driver, the commuter bus, and the second TNC driver.

20. The non-transitory machine-readable medium of claim 15, wherein the commuter travels from the origin to the destination by way of the commuter bus pick-up point and the commuter bus drop-off point using the first TNC driver, the commuter bus, and the second TNC driver.
